(19) United States
(12) Patent Application Publication
(10) Pub. No.: US 2005/0093422 A1
(43) Pub. Date: May 5, 2005

(54) White light-emitting device

(76) Inventors: Chien-Yuan Wang, Kaohsiung Hsien (TW); Ru-Shi Liu, Hsinchu Hsien (TW); Hung Yuan Su, Taipei Hsien (TW)

Correspondence Address: BIRCH STEWART KOLASCH & BIRCH, PO BOX 747, FALLS CHURCH, VA, 22040-0747, US

(21) Appl. No.: 10/697,029

(22) Filed: Oct. 31, 2003

(51) Int. Cl. H01J 1/62; H05B 33/00

(52) U.S. Cl. 313/487; 313/512

(57) ABSTRACT

A white light-emitting device comprising a blue or blue-green light-emitting diode emitting light of 450-500 nm wavelength, and two phosphor materials capable of emitting a yellow light with 520 to 580 nm wavelength, and a red light with 580 to 640 nm wavelength, respectively. The light-emitting diode and the two phosphor materials are packaged together to form the white light-emitting device.

### FIELD OF THE INVENTION

The present invention relates to a high-brightness white light-emitting device, especially to a high-brightness white light-emitting device with a blue or blue-green LED and two phosphors including a yellow phosphor and a red phosphor to emit yellow radiation and red radiation upon excitation.

### BACKGROUND OF THE INVENTION

A white light source is generally provided by mixing light source of different wavelength. For example, a conventional white light source can be realized by mixing red light, green light and blue light with suitable intensity ratio. Alternatively, the white light source can be realized by mixing yellow light and blue light with suitable intensity ratio. The conventional method for manufacturing white light source can be summarized as following:

In a first prior art of white light source, three LED dies based on AlInGaP, InGaN and Gap are packaged into a lamp and emit red light, blue light and green light, respectively. The light emitted from the lamp can be mixed by a lens to provide white light.

In a second prior art of white light source, two LED dies based on InGaN and AlInGaP or Gap are functioned to emit blue light and yellowish-green light. The blue light and yellowish-green light are mixed to provide white light. The white light sources according to above-mentioned two approaches have efficiency of 20 lm/W.

A third prior art of white light source is proposed by Nichia Chemical co., wherein an InGaN based blue LED and a yellow YAG phosphor are used to provide the white light source. This white light source requires uni-color LED to provide white light with efficiency 20 lm/W. Moreover, the phosphor is a mature art and commercially available.

A fourth prior art of white light source is proposed by Sumitomo Electric Industries Ltd., and uses a white-light LED based on ZnSe. A CdZnSe thin film is formed on the surface of a ZnSe crystalline substrate. The CdZnSe thin film is functioned to emit blue light and the ZnSe crystalline substrate emits yellow light after receiving the blue light of the CdZnSe thin film. The blue light and the yellow light are mixed to provide white light. In this approach, only one LED chip is required and the operation voltage thereof is 2.7 V, smaller than the 3.5 V operation voltage of the GaN based LED. Moreover, no phosphor is required.

In a fifth approach to provide white light source, an ultra-violet LED is used to excite two or more phosphors such that the phosphors luminesce lights of different colors for mixing into a white light.

In first and second prior art white light source, LEDs for multiple colors are required. The color of the white light source is distorted if one of the LEDs malfunctions. Moreover, the driving voltages for LEDs of different colors are also different; this complicates the design of driving circuit.

The third prior art white light source employs complementary color to achieve white light. However, the white light produced in this way has no uniform spectral distribution (especially in 400 nm-700 nm) as the natural white light such as sunlight. The white light thus produced has relatively chroma, which is, even indistinguishable to human eyes, differentiable to instrument such as camera. Therefore, the color rendering property and reproducing ability are not satisfactory and this white light source is used mainly for lighting.

The fourth prior art white light source has the drawbacks of low luminescent efficiency (only 8 lm/W) and short lifetime about 8000 hours.

In fifth prior art white light source, it is preferable to use three phosphors for emitting three different colors to enhance color rendering property. However, the phosphors should be prudently chosen to have absorption band matched with the wavelength of the exciting radiation. Moreover, the phosphors should have compatible absorption coefficients and quantum efficiency to provide white light of high quality.

### SUMMARY OF THE INVENTION

It is the object of the present invention to provide a white light-emitting device having an LED and two phosphors excited by the LED. The white light-emitting device has simpler process in comparison with prior art.

The white light-emitting device according to the present invention comprises a blue or blue-green light-emitting diode, a first phosphor capable of emitting a yellow light with 520 to 580 nm wavelength upon excitation by the blue or blue-green light-emitting diode, and a second phosphor capable of emitting a red light with 580 to 640 nm wavelength upon excitation by the blue or blue-green light-emitting diode, whereby those lights are mixed to a white light.

The formula of the first phosphor is preferably (YₓM_{y}Ce_{z})Al₅O₁₂, wherein x+y=3, and x [symbol] y≠0, 0.5>z>0, M is selected from a group consisting of Th, Lu and Yb, wherein (YₓM_{y}Ce_{z})Al₅O₁₂ is host matrix and Ce is luminescence center.

The formula of the second phosphor is preferably (M′ₐEu_{b})S, wherein a+b=11.2, and a, b≠0, M′ is selected from a group consisting of Ca, Sr and Ba, wherein M′ is host matrix and Eu is luminescence center.

In the white light-emitting device according to the present invention, only the blue or blue-green light-emitting diode consumes electrical power, therefore, the white light-emitting device can be operated with low current.

In the present invention, the crystal field of the host matrix of used phosphor is modulated to adjust the luminescent wavelength thereof. Moreover, the phosphor can be prepared by solid-state reaction method for mass production.

The white light-emitting device according to the present invention has following particular advantages:

1. The short-wavelength (below 470 nm) blue LED has the drawback of manufacture. The white light-emitting device according to the present invention uses long wavelength blue or blue-green LED, which has simpler process. Moreover, the long wavelength blue or blue-green LED has better efficiency in phosphor excitation.

2. In the present invention, the luminescent wavelength of phosphor is adjusted by modulating the crystal field of the host matrix of used phosphor instead of changing the amount of foreign ions. The process is simpler and more stable. The various objects and advantages of the present invention will be more readily understood from the following detailed description when read in conjunction with the appended drawing, in which:

### BRIEF DESCRIPTION OF DRAWING

FIG. 1 is the emission spectrum of the a white light-emitting device according to the present invention; and

FIG. 2 shows the CIE coordinate of the white light-emitting device of FIG. 1.

### DETAILED DESCRIPTION OF THE INVENTION

The present invention provide a white light-emitting device having an LED and two phosphors excited by the LED. The three colors generated by the LED and the two phosphors are mixed to provide a white light. The LED is a blue or a blue-green LED with emitting wavelength from 450 to 500 nm, preferably from 470 to 500 nm. The two phosphors include a yellow phosphor and a red phosphor to emit yellow radiation of 520-580 nm and red radiation of 580-640 nm. The yellow phosphor and the red phosphor can be mixed with a package material with different ratio to form a white light-emitting device with different color temperature and color rendering property.

The formula of the yellow phosphor is (YₓM_{y}Ce_{z})Al₅O₁₂, wherein x+y−3, and x [symbol] y≠0, 0.5>z>0, M is selected from a group consisting of Tb, Lu and Yb, wherein (YₓM_{y}Ce_{z})Al₅O₁₂ is host matrix and Ce is luminescence center. The formula of the red phosphor is (M′ₐEu_{b})S, wherein a+b=1˜1.2, and a, b≠0, M′ is selected from a group consisting of Ca, Sr and Ba, wherein M′ is host matrix and Eu is luminescence center. In above two phosphors, foreign ions are added into the host matrix and functioned as luminescence center upon receiving external excitation. The crystal filed is modulated to change the energy distribution of the luminescence centers. The wavelength of emitted light is also changed due to change in excited energy states.

A method for manufacturing the white light-emitting device according to the present invention has following steps:

1. Synthesizing a yellow phosphor with formula (YₓM_{y}Ce_{z})Al₅O₁₂, wherein x+y=3, and x, y≠0, 0.5>z>0, M is selected from a group consisting of Th, Lu and Yb. The synthesizing method can be one of chemical synthesizing, solid state reaction and organic metal thermal decomposition method, and the formula in the preferred embodiment is (Y_{0.8}Tb_{2.2}Ce_{0.05})Al₅O₁₂.

2. Synthesizing a red phosphor with formula (M′ₐEu_{b})S, wherein a+b=1˜1.2, and a, b≠0, M′ is selected from a group consisting of Ca, Sr and Ba. The synthesizing method can be one of chemical synthesizing, solid state reaction and organic metal thermal decomposition method, and the formula in the preferred embodiment is (Sr_{0.9}Eu_{0.1})S.

3. Mixing the above two prepared phosphors with epoxy resin and packaged with a blue-green LED with emitting wavelength 480 nm, thus forming a white light-emitting device.

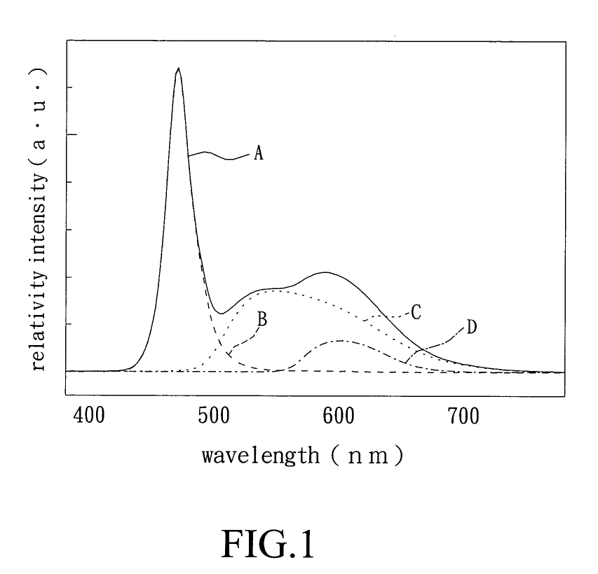

FIG. 1 shows the emission spectrum of the above embodiment, wherein curve A is the emission spectrum of the white light-emitting device and can be simulated with computer by adding those contribution from LED and phosphors. Moreover, in FIG. 1, curve B is the emission spectrum of the LED, curve C is emission spectrum of the yellow phosphor after excitation and curve D is emission spectrum of the red phosphor after excitation.

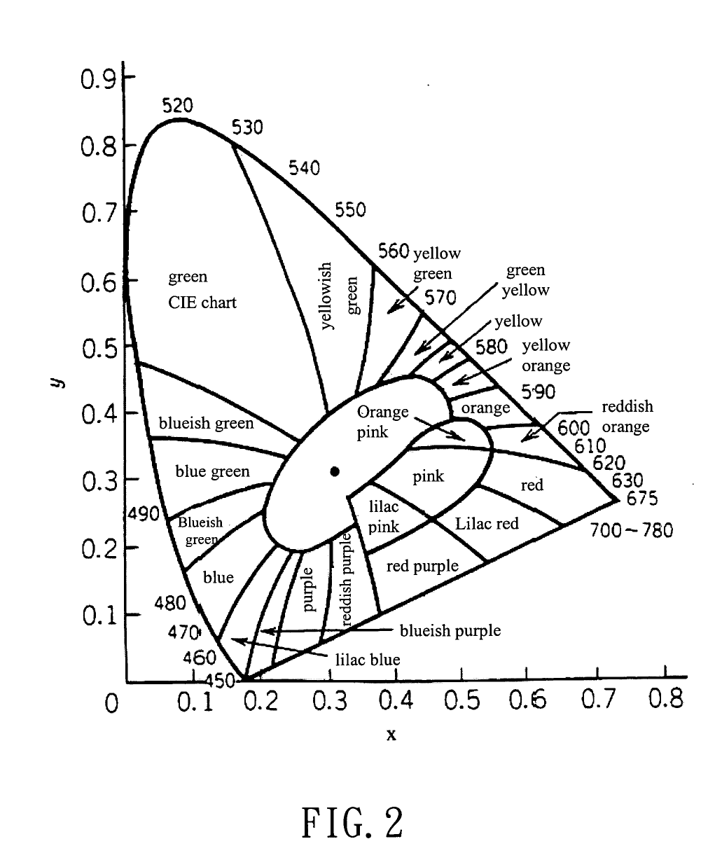

As shown in FIG. 2, the white light-emitting device manufactured according to the present invention emits a light with a CIE coordinate located at white region.

Although the present invention has been described with reference to the preferred embodiment therefore, it will be understood that the invention is not limited to the details thereof. Various substitutions and modifications have suggested in the foregoing description, and other will occur to those of ordinary skill in the art. Therefore, all such substitutions and modifications are intended to be embrace within the scope of the invention as defined in the appended claims.

1. A white light-emitting device, comprising:
a light-emitting diode emitting one of blue and blue-green color;
a first phosphor capable of emitting a yellow light with 520 to 580 nm wavelength upon excitation by the light-emitting diode, the formula of the first phosphor being (YₓM_{y}Ce_{z})Al₅O₁₂, where x+y=3, x and y≠0, 0<z<0.5, and M is selected from a group consisting of Tb, Lu and Yb, wherein (YₓM_{y}Ce_{z})Al₅O₁₂ is host matrix and Ce is luminescence center;
a second phosphor capable of emitting a red light with 580 to 640 nm wavelength upon excitation by the light-emitting diode, the formula of the second phosphor being (M′ₐEu_{b})S, where 1≦a+b≦1.2, a and b≠0, and M′ is selected from a group consisting of Ca, Sr and Ba, wherein M′ is host matrix and Eu is luminescence center;
the light from the light-emitting diode and the two phosphors being mixed to provide a white light.

2. The white light-emitting device as in claim 1, wherein the light-emitting diode emits a light of 450-500 nm wavelength, preferably 470-500 nm wavelength

3-4. (canceled)

5. The white light-emitting device as in claim 1, wherein the two phosphors are further mixed with a packaging material and each of the phosphors has a mixing ratio to change the color temperature and color rendering property of the white light-emitting device.
